(19) United States
(12) Patent Application Publication
(10) Pub. No.: US 2013/0275763 A1
(43) Pub. Date: Oct. 17, 2013

(54) APPARATUS AND METHOD FOR DIGITAL SIGNATURE AUTHENTICATION

(71) Applicant: SAMSUNG ELECTRONICS CO., LTD., Gyeonggi-do (KR)

(72) Inventors: Dong-Hyuk Lee, Seoul (KR); Do-Hyeon Kim, Gyeonggi-do (KR); Seong-Taek Hwang, Daegu (KR); Dong-Wook Kwon, Gyeonggi-do (KR); Dong-Chang Lee, Daegu (KR); Won-Suk Chang, Gyeonggi-do (KR)

(73) Assignee: Samsung Electronics Co., Ltd., Gyeonggi-do (KR)

(21) Appl. No.: 13/849,118

(22) Filed: Mar. 22, 2013

(30) Foreign Application Priority Data
Apr. 13, 2012 (KR) 10-2012-0038331

(51) Int. Cl. H04L 9/32

(52) U.S. Cl. CPC H04L 9/3247
USPC 713/176

(57) ABSTRACT

A digital signature authentication method and a digital signature authentication apparatus are provided in which a digital signature received from a user is structured and embedded into an agreement information file so that the digital signature may be managed safely and effectively. The method includes displaying an agreement information file and receiving the digital signature from a user; extracting signature data from the digital signature; and embedding the signature data into the agreement information file.

### PRIORITY

This application claims priority under 35 U.S.C. §119(a) to Korean Application Serial No. 10-2012-0038331, which was filed in the Korean Intellectual Property Office on Apr. 13, 2012, the entire content of which is incorporated herein by reference.

### BACKGROUND OF THE INVENTION

1. Field of the Invention

The present invention relates generally to an apparatus and method for digital signature authentication, and more particularly, to a digital signature authentication method and apparatus in which a digital signature received from a user is structured and embedded into an agreement information file so that the digital signature may be managed safely and efficiently.

2. Description of the Related Art

Currently, a demand for protection of information has increased according to the development of information and communication technology and widespread use of high-speed Internet. Accordingly, domestic and foreign governments, as well as companies, facilitate distribution of documents which are digitally signed through the use of a password and a digital signature, using a public key based structure.

In conventional digital signature and authentication technology, when registering the digital signature, each point of a user's digital signature is structured and converted into digital signature data in a separately defined format and the digital signature data is stored in a digital signature database (DB). The digital signature data includes information of an order in which each point is drawn according to an order of a user's drawing of the digital signature and information of a location of points.

After the digital signature data is stored in the digital signature DB in the above manner, authentication of the digital signature is performed as follows. First, when the digital signature is newly input by a user, the digital signature data, i.e., order information and location information of points, are extracted from the digital signature. Whether the authentication is successful or not is determined depending on similarity between the extracted digital signature data and a digital signature data that is already stored in the DB.

However, the above digital signature authentication method has a problem in that a separate DB for managing the digital signature data needs to be created and managed. For example, in a case of a financing related agreement, a party that provides a financing related service needs to separately store and manage the financing related agreement and a digital signature input by the user. Also, in a method of measuring the similarity by comparing the newly input digital signature data with the digital signature data stored in the digital signature DB, only the order information and the location information of the points are used, such that authentication results have a lower reliability.

### SUMMARY OF THE INVENTION

Accordingly, the present invention has been made to address at least the above-described problems occurring in the prior art, and to provide at least the advantages described below.

An aspect of the present invention is to provide a digital signature authentication method and apparatus in which a digital signature received from a user is structured and embedded into an agreement information file so that the digital signature may be managed safely and efficiently.

In accordance with an aspect of the present invention, a method of registering a digital signature in a digital signature authentication apparatus is provided. The method includes displaying an agreement information file and receiving the digital signature from a user; extracting signature data from the digital signature; and embedding the signature data into the agreement information file.

In accordance with another aspect of the present invention, a method of authenticating a digital signature in a digital signature authentication apparatus is provided. The method includes receiving the digital signature from a user; extracting first signature data from the digital signature; searching for at least one second signature data having a data capacity similar to that of the first signature data among pre-stored second signature data; determining similarity between the first signature data and the at least one second signature data; and determining whether authentication of the digital signature is successful according to the similarity.

In accordance with another aspect of the present invention, an apparatus for authenticating a digital signature is provided. The apparatus includes a user input unit for displaying an agreement information file and receiving the digital signature from a user; a data extraction unit for extracting signature data from the digital signature; and a data conversion unit for embedding the signature data into the agreement information file.

### BRIEF DESCRIPTION OF THE DRAWINGS

The above and other aspects, features, and advantages of the present invention will be more apparent from the following detailed description taken in conjunction with the accompanying drawings, in which:

FIG. 1 is a block diagram illustrating a configuration of a digital signature authentication apparatus according to an embodiment of the present invention;

FIG. 2 is a flow chart illustrating a method of registering a digital signature of a user in the digital signature authentication apparatus shown in FIG. 1;

FIG. 3A and FIG. 3B are screen shots illustrating an agreement information file according to an embodiment of the present invention;

FIG. 4 is a flow chart illustrating a method of authenticating a digital signature of a user in the digital signature authentication apparatus shown in FIG. 1;

FIG. 5A illustrates an example of signature data generated by the digital signature authentication apparatus shown in FIG. 1; and

FIG. 5B illustrates an example of a second agreement information file.

### DETAILED DESCRIPTION OF EMBODIMENTS OF THE INVENTION

Hereinafter, various embodiments of the present invention will be described with reference to the accompanying drawings. Particulars found in the following description of the present invention such as specific elements are provided only to facilitate a comprehensive understanding of the present invention, and it will be apparent to those skilled in the art that various changes or modifications may be made without departing from the spirit and scope of the invention.

For illustrative purposes, hereinafter, a digital signature that is input to be registered with a digital signature authentication apparatus 100, e.g., a digital signature input by a user to an agreement information file, is referred to as a “first digital signature.” Also, a digital signature that is input to the digital signature authentication apparatus 100 by the user for authentication after the first digital signature is registered, e.g., in order for the user to view the agreement information file, is referred to as a “second digital signature.”

Signature data of the first digital signature is referred to as “first signature data” and signature data of the second digital signature is referred to as “second signature data.” Also, an agreement information file prior to embedding the first signature data is referred to as a “first agreement information file” and an agreement information file into which the first signature data is embedded is referred to as a “second agreement information file.”

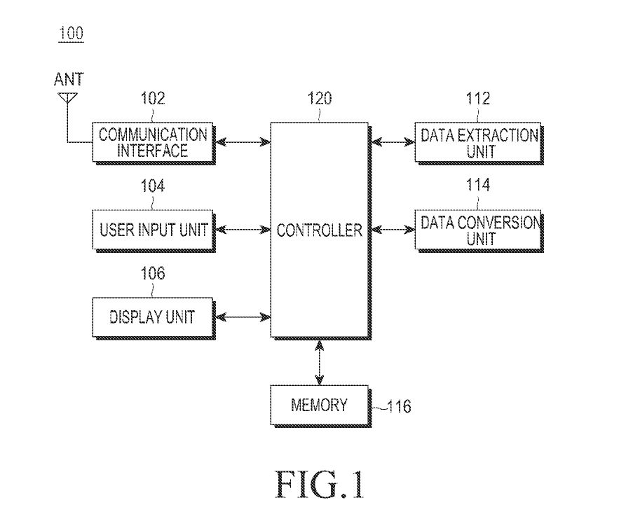

FIG. 1 is a block diagram illustrating a configuration of a digital signature authentication apparatus according to an embodiment of the present invention.

Referring to FIG. 1, the digital signature authentication apparatus 100 includes a user input unit 104, a data extraction unit 112, a data conversion unit 114, and a memory 116, and may further include a communication interface 102, a display unit 106, and a controller 120.

The communication interface 102 performs wired or wireless communication of the digital signature authentication apparatus 100. The communication interface 102 according to this embodiment transmits first signature data generated or converted by the digital signature authentication apparatus 100 to another digital signature authentication apparatus 100 or a digital signature server (not shown).

The user input unit 104 receives user input from a user. The user input unit 104 according to this embodiment receives a first digital signature or a second digital signature from the user. According to one embodiment, the user input unit 104 receives a user input for displaying a first agreement information file or a second agreement information file.

The display unit 106 displays various data stored in the digital signature authentication apparatus 100. The display unit 106 according to this embodiment displays the first digital signature or the second digital signature input by the user.

According to one embodiment of the present invention, the user input unit 104 and the display unit 106 may be implemented in a form of a touch screen to receive the digital signature from the user while displaying the input digital signature at the same time. Also, the display unit 106 may display the first agreement information file or the second agreement information file. The display unit 106 displays that the authentication is successful or may display that the authentication is not successful.

The data extraction unit 112 extracts signature data of the first digital signature or the second digital signature, i.e., the first signature data or second signature data, input through the user input unit 104.

The signature data includes a signature image or signature information. The signature image indicates a digital signature that is converted into a form of an image. Also, the signature information includes a parameter that indicates various information of the digital signature input from the user. The parameter included in the signature information may include at least one of a start marker of the signature data, a number of total strokes of the digital signature, a stroke index of each of strokes included in the digital signature, a number of dots included in each of the strokes, location information indicating a location of the digital signature, pressure information indicating pressure applied by the user to the user input unit 104 (for example, the touch screen) while the user inputs the digital signature, generation time information indicating a time period in which the digital signature is generated by the user, a size of each of the strokes, data capacity of the signature data, and a termination marker. Here, when the user input unit 104 is the touch screen, the location of the digital signature indicates a coordinate at which the digital signature is input on the touch screen or respective coordinates of the dots included in the digital signature. Also, data capacity of the digital signature indicates a capacity of an entire corresponding signature data.

The data conversion unit 114 structures and converts the first signature data or the second signature data extracted by the data extraction unit 112. The data conversion unit 114 converts the signature data into an image file such as a Joint Photographic Experts Group (JPEG) image or a Portable Document Format (PDF) image. Also, the data conversion unit 114 embeds the first signature data, which is converted into the image file, into the first agreement information file.

The first agreement information file refers to a file loaded onto the digital signature authentication apparatus 100 in order to receive the first digital signature from the user. The first agreement information file may be, for example, a financing agreement file. According to one embodiment of the present invention, in a process of structuring and converting the signature data, the data conversion unit 114 inserts the data capacity of the signature data immediately in front of the termination marker.

When the first agreement information file is displayed through the display unit 106, the user input unit 104 receives the first digital signature from the user. The data conversion unit 114 separately stores only the first signature data, into which the input first digital signature is converted, in the memory 116. Also, the data conversion unit 114 stores the first agreement information file in which the first signature data is included, i.e., the second agreement information file in the memory 116. The data conversion unit 114 converts the first agreement information file in which the first signature data is not included into the second agreement information file by embedding the first signature data into the first agreement information file.

The memory 116 stores various data for controlling operations of the digital signature authentication apparatus 100. According to one embodiment of the present invention, the memory 116 stores the first digital signature or the second digital signature, the first signature data or the second signature data, or the first agreement information file or the second agreement information file.

The controller 120 controls an overall operation of the digital signature authentication apparatus 100. The controller 120 according to the present invention controls the display unit 106 to display the first agreement information file stored in the memory 116. When the first agreement information file is displayed, the controller 120 determines whether the first digital signature is input through the user input unit 104. When the first digital signature is input, the controller 120 controls the data extraction unit 112 to extract the first signature data of the first digital signature. Also, when the first signature data is extracted, the controller 120 controls the data conversion unit 114 to embed the first signature data into the first agreement information file to convert the first agreement information file into the second agreement information file. When the first agreement information file is converted into the second agreement information file, the controller 120 stores the second agreement information file in the memory 116.

Also, the controller 120 performs authentication of a newly input digital signature, i.e., the second digital signature. The controller 120 performs authentication of the second digital signature by determining whether the first digital signature that is similar to the second digital signature is already stored in the digital signature authentication apparatus 100.

When the second digital signature is input from the user for authentication, the controller 120 controls the data extraction unit 112 in order to extract the second signature data of the second digital signature. Here, the controller 120 controls the data conversion unit 114 to insert the parameter of data capacity of the second signature data immediately in front of the termination marker among various parameters included in the second signature data. In other words, the data conversion unit 114 structures the second signature data such that the parameter indicating the data capacity of the second signature data is located in front of the termination marker.

The controller 120 searches for the first signature data similar to the second digital signature by using a parameter indicating the data capacity of the second signature data, i.e., a data capacity parameter. The controller 120 reads the second signature data in a reverse order from the termination marker to the data capacity parameter of the second signature data to identify the data capacity of the second signature data. Also, the controller 120 reads respective first signature data stored in the memory 116 in a reverse order from the termination marker to the data capacity parameter of the first signature data. The controller 120 extracts the first signature data having data capacity similar to the data capacity of the second signature data among the first signature data stored in the memory 116. When reading in the reverse order from the termination marker to the data capacity parameter, the controller 120 saves a significant amount of time compared to reading from a start marker to the termination marker. By reading in an order from the termination marker to the data capacity parameter, the digital signature authentication apparatus 100 according to the present invention reduces the time required to search for at least one first signature data that is similar to the second signature data. Also, since only the termination marker and the data capacity parameter need to be read, the digital signature authentication apparatus 100 a significantly reduces a computation amount as compared to a case of reading from the start marker.

The controller 120 compares the first signature data with the second signature data to determine similarity therebeteween. When the similarity is determined, the controller 120 determines whether the similarity between the first signature data and the second signature data is greater than or equal to a reference value. For example, if the similarity between the first signature data and the second signature data greater than or is equal to 80%, the controller 120 determines that the authentication of the second digital signature is successful. To the contrary, if the similarity between the first signature data and the second signature data is less than 80%, the controller 120 may determine that the authentication of the second digital signature is unsuccessful.

Here, the controller 120 compares signature images of the first signature data and the second signature data and various parameters included in the signature information to calculate a ratio of the same part, thereby determining the similarity.

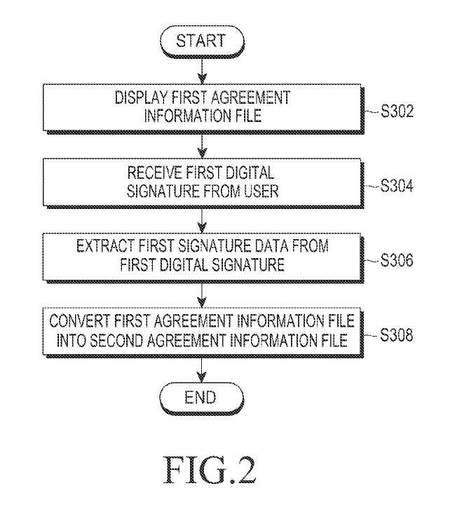

FIG. 2 is a flow chart illustrating a method of registering a digital signature of a user in the digital signature authentication apparatus shown in FIG. 1.

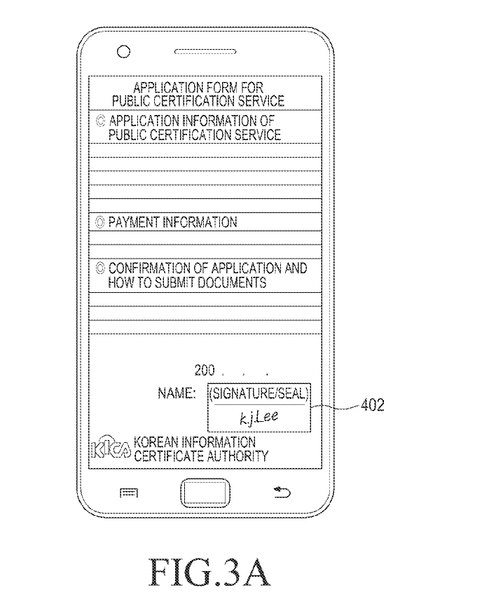

Referring to FIG. 2, the digital signature authentication apparatus 100 displays the first agreement information file at step S302. The digital signature authentication apparatus 100 displays the first agreement information file to receive the first digital signature from the user at step S304. In an embodiment of the present invention, the digital signature authentication apparatus 100 which displays the first agreement information file receives the first digital signature from the user through a digital signature input form as shown in FIG. 3A and FIG. 3B.

When the first digital signature is received, the data extraction unit 112 of the digital signature authentication apparatus 100 extracts the first signature data from the first digital signature at step S306. When the first signature data is extracted, the data conversion unit 114 converts the first agreement information file into the second agreement information file at step S308. The second agreement information file may be generated by embedding the first signature data into the first agreement information file.

According to an embodiment of the present invention, the first agreement information file is stored separately from the second agreement information file. Also, according to another embodiment, the digital signature authentication apparatus 100 stores the first signature data extracted in step S306 in the memory 116 separately from the second agreement information file.

FIG. 3A and FIG. 3B illustrate an agreement information file according to an embodiment of the present invention.

As shown in FIG. 3A and FIG. 3B, the first agreement information file displayed through the display unit 106 of the digital signature authentication apparatus 100 may include digital signature input forms 402, 404. The user may input the first digital signature in the digital signature input forms 402, 404 by using a stylus pen, etc. The digital signature authentication apparatus 100 receives the first digital signature from the user through the digital signature input forms 402, 404. In FIG. 3A and FIG. 3B, ‘k.j.Lee’ input to the digital signature input forms 402, 404, i.e., a signature line thereof, is the first digital signature input by the user.

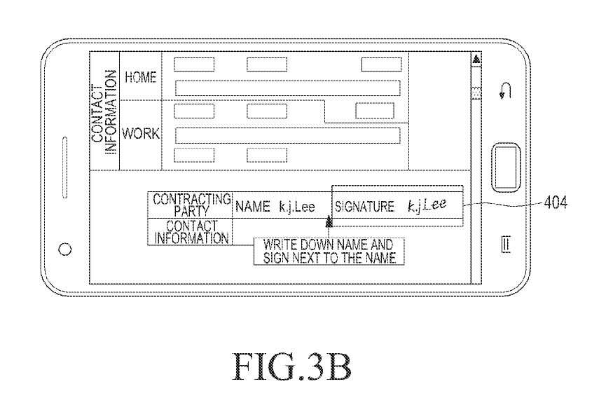

FIG. 4 is a flow chart illustrating a method of authenticating a digital signature of a user in the digital signature authentication apparatus shown in FIG. 1.

Referring to FIG. 4, the digital signature authentication apparatus 100 receives the second digital signature for authentication from the user at step S312. The digital signature authentication apparatus 100 extracts the second signature data from the second digital signature at step S314.

When the second signature data is extracted, the controller 120 of the digital signature authentication apparatus 100 searches for the first signature data similar to the second signature data in the memory 116 at step S316. Among the signature information included in the respective first signature data stored in the memory 116, the controller 120 reads a parameter indicating the data capacity of the first signature data to search for the first signature data having the data capacity similar to that of the second signature data extracted in step S314.

The controller 120 quickly extracts the first signature data having similar or the same data capacity as that of the second signature data by reading the respective first signature data stored in the memory 116 from the termination marker. According to another embodiment, the controller 120 controls the communication interface 102 to request a digital signature database (DB) (not shown) to transmit the first signature data having the data capacity similar to that of the second signature data.

When the first signature data similar to the second signature data is searched for, the controller 120 determines the similarity therebetween by comparing the first signature data with the second signature data at step S318.

The controller 120 determines whether the similarity between the first signature data and the second signature data is greater than or equal to a reference value at step S320. When the similarity is greater than or equal to the reference value according to a determination result of step S320 ('YES' to step S320), the digital signature authentication apparatus 100 determines that the digital signature input by the user in step 312 is an effective digital signature, and the controller 120 determines that the authentication is successful at step S322. If the authentication is successful, the controller 120 controls the display unit 106 to display that the authentication is successful at step S324.

When the similarity is less than the reference value according to the determination result of step S320 (‘NO’ to step S320), the controller 120 of the digital signature authentication apparatus 100 determines that the digital signature input by the user in step 312 is an ineffective digital signature, and the controller 120 determines that the authentication is unsuccessful at step S326. If the authentication is unsuccessful, the controller 120 controls the display unit 106 to display that the authentication is unsuccessful at step S328.

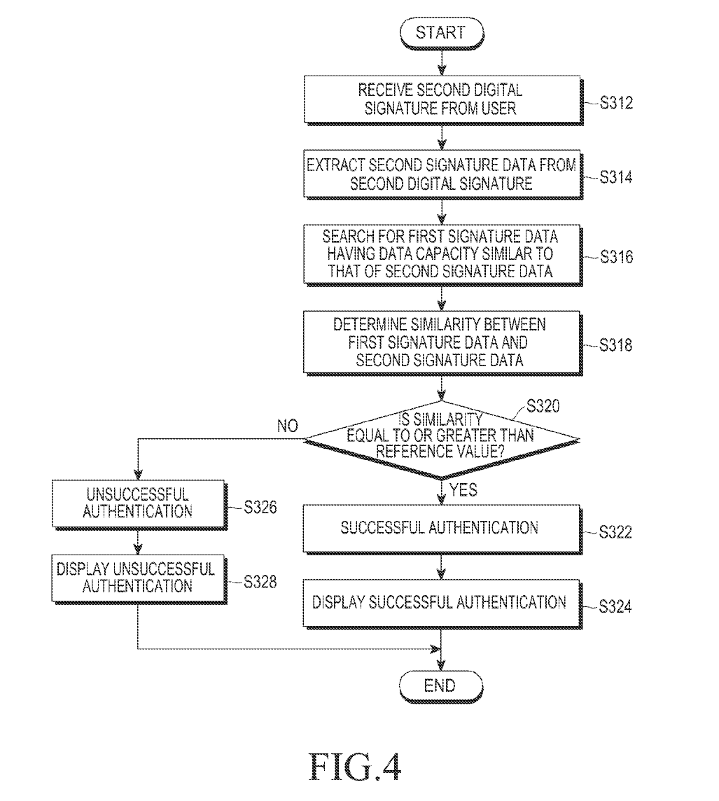

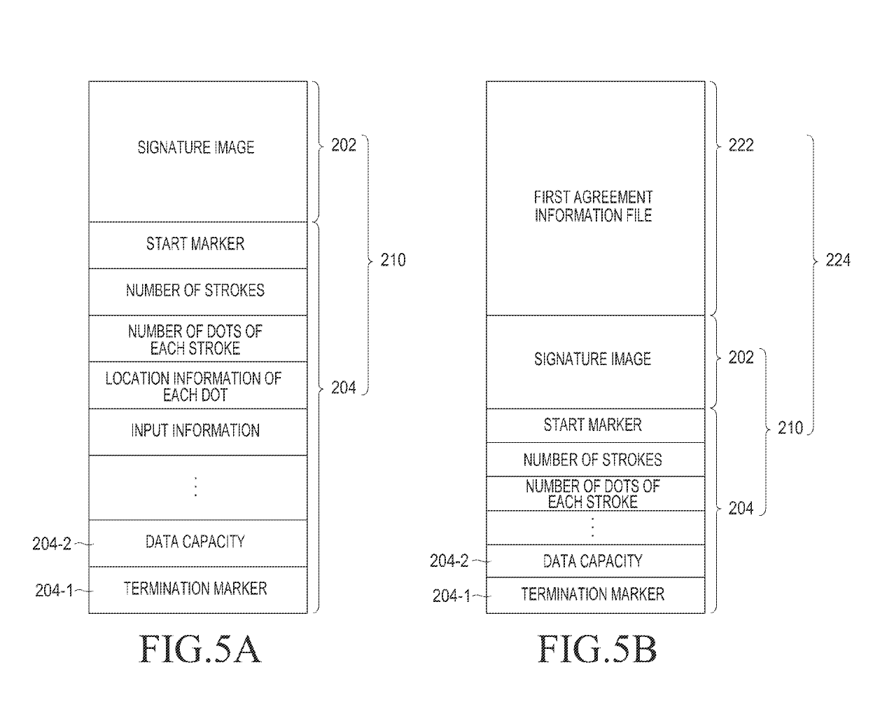

FIG. 5A illustrates an example of signature data generated by the digital signature authentication apparatus shown in FIG. 1, and FIG. 5B illustrates an example of a second agreement information file.

Referring to FIG. 5A, signature data 210 includes a signature image 202 and signature information 204. Also, referring to FIG. 5B, a second agreement information file 224 includes a first agreement information file 222, the signature image 202, and the signature information 204. Thus, the second agreement information file 224 may be the signature data 210 in addition to the first agreement information file 222.

When the digital signature authentication apparatus 100 performs authentication, the controller 120 of the digital signature authentication apparatus 100 reads a termination marker 204-1 and data capacity 204-2 of a corresponding signature data among the signature data 210 or the signature information 204 included in the second agreement information file 224 to search for signature data required for authentication.

Embodiments of the present invention may be implemented by hardware, software, or a combination of hardware and software. The software may be stored in a volatile or non-volatile storage device including a storage device such as a Read-Only Memory (ROM) or a memory such as a Random Access Memory (RAM), a memory chip, or an integrated circuit, and a storage medium such as a compact disk (CD), a Digital Versatile Disk (DVD), a magnetic disk, or a magnetic tape which enables an optical or magnetic recording, as well as being readable by a machine, regardless of whether the storage device is removable or re-writable. It should be understood that the memory is an example of a machine-readable storage medium suitable for storing a program or programs including instructions that implement embodiments of the present invention. Therefore, the present invention includes a machine-readable storage medium that stores a program or programs including codes for implementing a method described by the appended claims. Also, such a program may be electrically transmitted through any medium similar to a communication signal that is propagated by wire or wirelessly, and the present invention includes equivalents thereof.

The digital signature authentication apparatus may receive and store the program from a program providing apparatus wirelessly connected or connected by wire thereto. The program providing apparatus may include a program including instructions for the digital signature authentication apparatus to follow to perform a method of registering and authenticating the digital signature, a memory for storing information needed for the method of registering and authenticating the digital signature, a communication unit for performing wired or wireless communication with the digital signature authentication apparatus, and a controller for transmitting a corresponding program to the digital signature authentication apparatus at a request of the digital signature authentication apparatus or automatically.

According to the present invention, a digital signature authentication method and a digital signature authentication apparatus in which a digital signature received from a user is structured and embedded into an agreement information file so that the digital signature may be managed safely and easily are provided.

While the present invention has been shown and described with reference to certain embodiments thereof, it will be understood by those skilled in the art that various changes in form and details may be made therein without departing from the spirit and scope of the present invention as defined by the appended claims.

What is claimed is:

1. A method of registering a digital signature in a digital signature authentication apparatus, the method comprising:
displaying an agreement information file and receiving the digital signature from a user;
extracting signature data from the digital signature; and
embedding the signature data into the agreement information file.

2. The method of claim 1, wherein the signature data comprises a data capacity parameter that indicates capacity of the signature data.

3. The method of claim 2, wherein the data capacity parameter is inserted immediately in front of a termination marker of the signature data.

4. A method of authenticating a digital signature in a digital signature authentication apparatus, the method comprising:
receiving the digital signature from a user;
extracting first signature data from the digital signature;
searching for at least one second signature data having a data capacity similar to that of the first signature data among second signature data;
determining similarity between the first signature data and the at least one second signature data; and
determining whether authentication of the digital signature is successful according to the similarity.

5. The method of claim 4, wherein determining whether authentication of the digital signature is successful comprises:
determining whether the similarity is greater than or equal to a reference value; and
determining that the authentication of the digital signature is successful when the similarity is greater than or equal to the reference value.

6. The method of claim 5, further comprising:
determining that the authentication of the digital signature is unsuccessful when the similarity is less than the reference value.

7. The method of claim 4, wherein searching for the at least one second signature data comprises:
reading a data capacity parameter included in each of the second signature data to extract the at least one second signature data having the data capacity similar to that of the first signature data.

8. An apparatus for authenticating a digital signature, the apparatus comprising:
a user input unit for receiving a user input for displaying an agreement information file and for receiving the digital signature from a user;
a data extraction unit for extracting signature data from the digital signature; and
a data conversion unit for embedding the signature data into the agreement information file.

9. The apparatus of claim 8, wherein the signature data includes a data capacity parameter indicating capacity of the signature data.

10. The apparatus of claim 9, wherein the data capacity parameter is inserted immediately in front of a termination marker of the signature data.

11. The apparatus of claim 8, wherein, when the user input unit receives the digital signature from the user, the data extraction unit extracts a first signature data from the digital signature.

12. The apparatus of claim 11, further comprising:
a controller configured to:
search for at least one second signature data having a data capacity similar to that of the first signature data among second signature data when the first signature data is extracted,
determine a similarity between the first signature data and the at least one second signature data, and
determine whether authentication of the digital signature is successful according to the similarity.

13. The apparatus of claim 12, wherein the controller determines whether the similarity is greater than or equal to a reference value and determines that the authentication of the digital signature is successful when the similarity is greater than or equal to the reference value.

14. The apparatus of claim 13, wherein the controller determines that the authentication of the digital signature is unsuccessful when the similarity is less than the reference value.

15. The apparatus of claim 12, wherein the controller reads a data capacity parameter included in each of the second signature data to extract the at least one second signature data having the data capacity similar to that of the first signature data.

16. The apparatus of claim 15, wherein the data capacity parameter is a parameter inserted immediately in front of a termination marker included in the first signature data and each of the at least one second signature data.

17. The apparatus of claim 16, wherein the controller reads the second signature data in an order from the termination marker to the data capacity parameter to extract the at least one second signature data.
